(19) United States
(12) Patent Application Publication
(10) Pub. No.: US 2017/0178551 A1
(43) Pub. Date: Jun. 22, 2017

(54) CHANNEL LETTER SIGN ASSEMBLY

(71) Applicants: Clyde H. Boyer, Concord, OH (US); Duane Colford, Skowhegan, ME (US)

(72) Inventors: Clyde H. Boyer, Concord, OH (US); Duane Colford, Skowhegan, ME (US)

(21) Appl. No.: 15/381,915

(22) Filed: Dec. 16, 2016

Related U.S. Application Data
(60) Provisional application No. 62/269,319, filed on Dec. 18, 2015.

(51) Int. Cl. G09F 13/06; G09F 13/22

(52) U.S. Cl. CPC G09F 13/06; G09F 13/22; G09F 2013/222; G09F 2013/0418

(57) ABSTRACT

A channel letter has a rear surface for mounting against a raceway, wall, or a structure for supporting the signage, and sheet metal sides defining the figuration of the letter or shape to be depicted. A lighting element is positioned against the rear surface of the enclosure, and a lens is retained to the open front of the enclosure. The lens is secured with a retainer cap and a plurality of retainer clips. Each of the retainer clips has as least one side including an outwardly extending leg for retention with the retainer cap.

### CLAIM OF PRIORITY

This application claims priority from Provisional Patent Application Ser. No. 62/269,319 filed on Dec. 18, 2015, the entity of which is hereby incorporated by reference.

### FIELD OF THE DISCLOSURE

The present disclosure relates to channel letters of the type used to create signage. In particular, it relates to an improved retainer clip and trim cap, and a method of manufacturing same, along with a tool for retaining the trim cap and lens to the enclosure of a channel letter.

### BACKGROUND OF THE DISCLOSURE

Channel letters are used to provide signage for buildings, shopping malls, and the like where it is desirable that the signage comprise illuminated letters or any other shapes that are easily seen, even at great distances, day or night. Each channel letter includes an enclosure, usually a metal box, having a rear surface which is positioned against a raceway, or the wall of a building, on which the signage is mounted and a plurality of sides which define the figuration of a letter or number (or other shape) which make up a portion of the sign. A light source, such as a neon tube, LEDs, or other lighting mechanisms, can be positioned within the walls of the enclosure and attached to the rear (and/or side) surface to provide illumination for the letter or shape.

The light sources used in many existing channel letters are neon bulbs requiring high voltage power with transformers built into the metal enclosures. To prevent injury to those servicing such channels letters many municipalities require that such letters be inspected to ensure that they are adequately sealed using standards set by Underwriters Laboratories.

It is expected that relatively new technology in lighting sources will soon become the most prevalent for the manufacturers of channel letters. Specifically, low voltage LED type light sources have been developed which provide a very long lasting bright light without requiring the high voltage and transformers needed for neon lighting. It is expected that channel letters employing the new technology will not be required to meet the same standards set by Underwriters Laboratories for neon tubes.

In addition to the lighting, a channel letter also includes a planar transparent lens, the outer shape of which corresponds to the figuration of the letter or any other shape defined by the sides of the enclosure. The manufacture of the lens requires that the planar panel of transparent plastic be cut to the shape of the enclosure. The lens of existing channel letters can have a trim cap glued or welded to the outer edges thereof which form a border to the lens. The trim cap also has a lip which, when assembled to the enclosure, is shaped to fit snugly around the forward ends of the walls thereof for retaining the lens to the enclosure and to maintain the water tight seal required by Underwriters Laboratories. Heretofore, typically screws are threaded through the lips of the trim cap and into the enclosure walls to retain the lens across the forward opening of the enclosure.

It would be desirable to provide a channel letter assembly having a lens, trim cap, and retaining clips which could be easily installed without incurring the labor intensive, and aesthetically displeasing, step of attaching the trim cap with screws. It would also be desirable to provide a less cumbersome and adjustable method of initial assembly of the retainer clips, trim cap, and lens to the enclosure of a channel letter. It would further be desirable to provide a less cumbersome method of disassembling the trim cap and lens to gain access to the interior of the enclosure of a channel letter. And still further, it would be desirable to provide improved materials and methods of manufacturing the retainer clips and trim cap.

### BRIEF DESCRIPTION OF THE DISCLOSURE

Briefly, the present disclosure is embodied in a channel letter assembly. For the purposes of this description, a channel letter is defined as an illuminated contoured fixture in the shape of a letter of the alphabet, a numeral, an element of punctuation such as a comma, an exclamation point, or any other shape or form intended to constitute a portion of a sign advertisement or display.

In accordance with a preferred embodiment of the disclosure, the channel letter has a rear surface for mounting against a raceway, a wall, or any other structure suitable for supporting the signage. The walls defining the figuration of the letter or shape to be depicted are made of sheet metal, or plastic, having a given thickness. A lighting element, such as a strip of LEDs according to the newly available technology or any other light source, is positioned against, or proximal to, the rear surface of the enclosure to provide illumination therefore.

In accordance with another embodiment of the disclosure, a channel letter has an enclosure having at least two opposing walls, wherein the at least two opposing walls define the shape of the letter and have an open front. The opposing walls have an inner surface and a forward end. A lens has a forward surface and an outer edge in the shape of the letter. A plurality of selectively positioned and oriented retention or retaining clips are adjacent the forward end and frictionally engage with the enclosure walls. Each clip includes an outwardly extending leg relative to the walls. A retainer or trim cap is positioned against the forward surface of the lens for retaining the lens adjacent the enclosure and the walls. The retainer cap includes a liner-less extrusion readily formable into a variety of shapes. The retainer cap also includes an interior face having a first edge and an opposing second edge. The first edge has an overhang engaged to the forward surface of the lens. The second edge has a channel adapted to securely engage a plurality of the legs along an outer surface of the enclosure walls.

In accordance with another embodiment of the disclosure, a channel sign assembly has an enclosure having at least two opposing walls. The opposing walls define the shape of the sign assembly and have an open front. The opposing walls have an inner surface and a forward end. The walls include a plurality of intermittent retention clips mounted adjacent to the forward end. Each clip includes an outwardly extending leg relative to the walls. The legs are aligned with and offset from the forward end. A planar lens has a forward surface, and an outer edge in the defined shape of the sign and sized to fit within the opposing walls of the enclosure. A retainer or trim cap is positioned against the forward surface of the lens for retaining the lens within the enclosure and against the walls. The retainer cap has a liner-less extrusion readily formable into a variety of shapes. The retainer cap includes an interior face having a first edge and an opposing second edge. The first edge has an overhang engaged with the forward surface of the lens. The second edge forming a retention channel. The channel is adapted to securely engage a plurality of the legs along an outer surface of the enclosure walls.

In accordance with another embodiment of the disclosure, a channel sign assembly has an enclosure having at least two opposing walls defining the shape of the sign assembly and having an open front. The opposing walls forms a forward end. The walls include a plurality of intermittent retention clips mounted adjacent to the forward end. Each clip is mounted in a first orientation including a first outwardly extending leg relative to the walls. The legs are aligned with and offset from the forward end. A planar lens has a forward surface and an outer edge in the defined shape of the sign. A trim cap is mounted against the forward surface of the lens for retaining the lens within the enclosure and against the walls. The trim cap has a liner-less extrusion readily formable into a variety of shapes. The trim cap includes an interior face having a first edge and an opposing second edge. The first edge has an overhang engaged with the forward surface of the lens. The second edge forms a retention channel, wherein the channel is adapted to securely engage a plurality of the legs along an outer surface of the enclosure walls.

In accordance with another embodiment of the disclosure, a channel sign assembly has an enclosure having at least two opposing walls. The opposing walls define the shape of the sign assembly and have an open front. The opposing walls form a forward end. The walls include a plurality of intermittent retention clips mounted adjacent to the forward end. Each clip includes a unitary structure including a top edge, a planar body, and an outwardly extending leg relative to the body. The plurality of clips and associated legs are aligned with and offset from the forward end. The sign assembly further includes a planar lens having a forward surface and an outer edge in the defined shape of the sign. A retainer cap can be mounted against the forward surface of the lens for retaining the lens within the enclosure and against the walls. The clips can further include an adhesive bond for securing the clip to the channel wall. The top edge of the clip can include a first portion generally at about 90° to the body for resting on the forward end and stopping the clip at the proper mounting position.

Still other aspects of the disclosure will become apparent upon a reading and understanding of the following detailed description.

### BRIEF DESCRIPTION OF THE DRAWINGS

A better and more complete understanding of the present disclosure will be had after a reading of the following detailed description taken in conjunction with the drawings wherein:

FIG. 1 is a side elevational view of a retention or retainer clip according to a first embodiment of the disclosure;

FIG. 2 is a front elevational view of the retainer clip of FIG. 1;

FIG. 3 is a bottom plan view of the clip of FIG. 1;

FIG. 4 is a side elevational view of the clip of FIG. 1 installed on a wall;

FIG. 5 is a side elevational view of a retainer clip according to a second embodiment of the disclosure;

FIG. 6 is front elevational view of the retainer clip of FIG. 5;

FIG. 7 is a front elevational view of a punch tool in accordance with another embodiment of the disclosure;

FIG. 8 is a rear elevational view of the punch tool of FIG. 7;

FIG. 9 is a cross sectional view of a liner-less trim cap;

FIG. 10 is a front elevational view of a plurality of clips and an alternative ‘notched’ mounting position in accordance with another embodiment of the disclosure.

### DETAILED DESCRIPTION OF THE DISCLOSURE

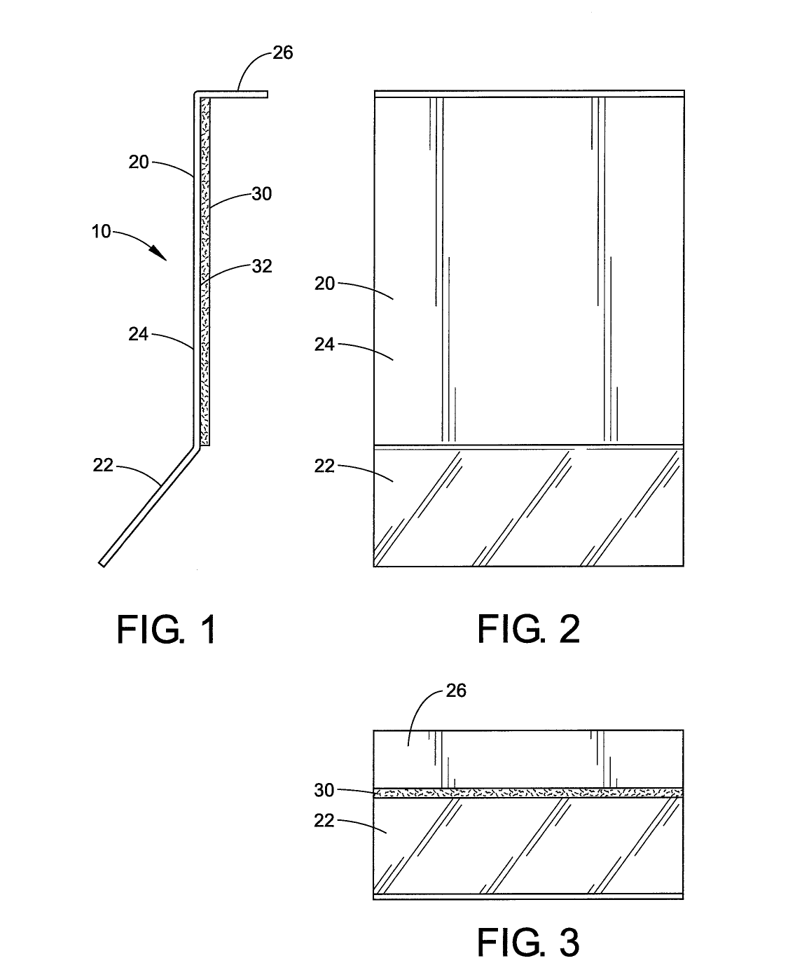

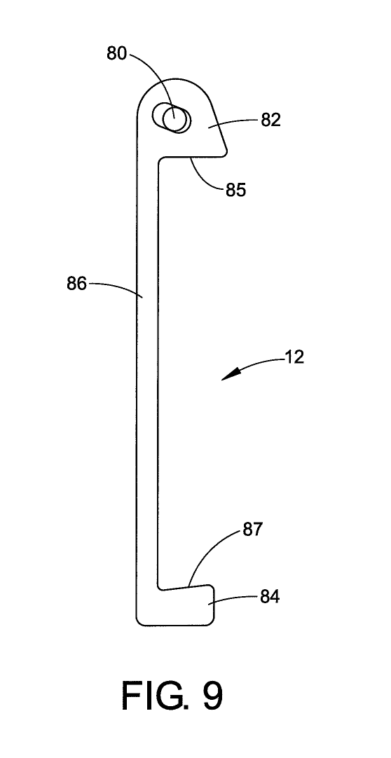

Referring now to FIGS. 1-4, and in accordance with a preferred embodiment of the present disclosure, a channel letter assembly utilizing a retaining clip 10 is therein shown. The clip 10 provides a means for securing a trim cap or retainer cap 12 to the walls of the enclosure. To be described in more detail hereinafter, it is to be appreciated that a trim cap 12 (FIG. 9) can comprise a liner-less extrusion while maintaining rigidity and formability to the trim cap shape. To facilitate retention of a lens 40 against front edges 16 of the walls 18 of the enclosure, a plurality of retainer clips 10 are spaced along the front edges or terminal ends of the walls of the enclosure.

In a first preferred embodiment, each of the individual retainer clips 10 can be cut from a continuous extrusion and comprise a unitary rigid body 20 having a first leg 22, a first wall 24, and an angled top side 26. A plurality of such retainer clips can be cut and positioned around the outer edge 16 of the walls 18 thereby providing an attachment means for the trim cap 12 and lens 40 to the walls of the enclosure. Retaining the trim cap 12 to the walls 18 of the enclosure in turn provides the means for securing the lens 40 to the enclosure walls thereby providing a water resistant cover to the interior of the enclosure.

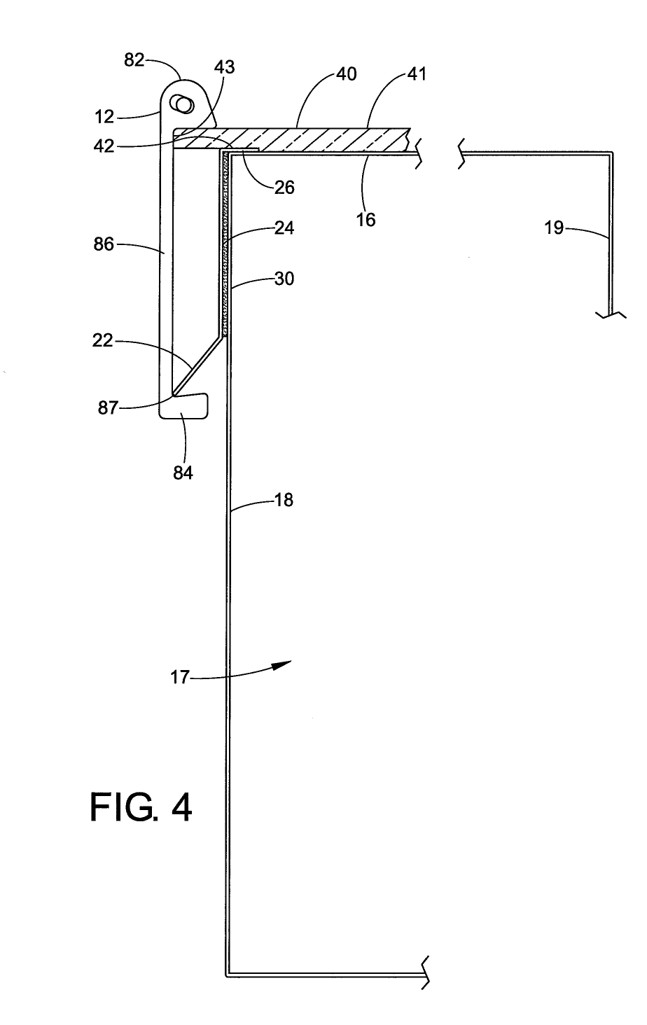

The retainer clip 10 is fitted on the forward end or front edge 16 of a wall 18 with the leg 22 extending outward away from the wall. When all the retainer clips have been installed along the walls of the enclosure the lens 40 can be positioned to rest on an outer surface 42 of the clips as seen in FIG. 4.

It should also be appreciated that the retainer clips 10 may be manufactured and/or cut in more than one size to provide desirable fitting between the sides and clips in order to accommodate a variety of wall thicknesses (and materials), and a variety of installation means. It is to be appreciated that the channel enclosure can be made from non-metal materials (i.e. rigid or semi-rigid plastics). Non-metal materials can be used in conjunction with retainer clips 10 and trim cap 12 discussed herein.

To further secure the clips to the enclosure walls, an adhesive or double-faced tape 30 can used to secure the clips along the walls. The tape is fastened to a side 32 of the wall 24. A plurality of such retainer clips can be positioned around the front edge of the walls thereby providing an attachment means for the trim cap 12 to the walls of the enclosure. Retaining the trim cap (in place) in turn provides the means for securing the lens to the enclosure walls.

Referring to FIG. 4, the clips 10, once installed, provide a tab or leg 22 that extends outward away from the walls 18 of the channel and can engage face 87 of a foot 84 of the retainer or trim cap 12 (i.e. in a “snap fit” or friction engagement arrangement). The foot can extend in a length from about 0.1 inch to about 0.2 inches from cap body wall 86. The foot of the retainer cap can be in the form of a receiver or retention channel having a face 87 angled upward from about 3 degrees to about 11 degrees from horizontal. In one arrangement, the receiver can be angled upward from about 6 degrees to about 8 degrees from horizontal.

The clips 10 can be placed onto the channel walls 18 at random positions around the letter or shape at the discretion of an installer. The number and intermittent spacing of the clips will be dependent upon the size and design of the channel sign. The interlocking effect of the foot 84 of the retainer cap to the tabs 22 will enable secure attachment of the plastic lens 40 and retainer cap 12 to the metallic channel. The tabs of the clips can be positioned such that they are aligned with and proximal to the front edge of the side walls.

The retainer clips 10 can be fitted on the forward end of a wall with the leg 22 extending outward away from the wall. The retaining clips can be easily installed, in one arrangement, with an adhesive epoxy or glue or tape 30 secured to the inside of the body. When all the retainer clips have been installed along the walls of the enclosure, the lens 40 can be positioned to rest on the outer surface 42 of the top edge 26 of the clips. It is to be appreciated that after a retainer clip has been installed, the top edge will rest against the front edge of the wall and along with the adhesive epoxy will resist removal of the retainer clip. The planar transparent and translucent lens 40 has a forward surface or outside face 41, and an outer edge 43 in a defined shape of the sign and is sized to fit adjacent to cap 12 and two opposing walls 18, 19 of the enclosure 17. Retainer cap 12 has surface 85 which is mounted against and secured to forward or upper surface 41 of the lens 40 by friction or other means for mounting and securing the lens 40 to enclosure 17 and adjacent walls 18, 19.

In accordance with the present disclosure, to retain the lens against the walls of the letter sign, a plurality of retainer clips 10 are spaced along the outer end of the walls of the enclosure. Each of the retainer clips can comprise a unitary generally rigid body having a first interior side and a second exterior side. The top edge 26, body 24, and leg 22 of the clip can be cut from a cured rigid plastic extrusion. Also, the top edge can be at a generally 90 degree angle relative to the body. The top edge resting on the front edge of the wall, coupled with the adhesive epoxy or, in another arrangement, double-faced adhesive tape 30 secured between the body and wall, resists removal of the clip. A plurality of such retainer clips can be positioned around the front edge of the walls thereby providing an attachment means for the trim cap to the walls of the enclosure. Retaining the trim cap (in place) in turn provides the means for securing the lens to the enclosure walls.

The adhesive epoxy 30 securing the clips 10 to the wall 18 enables a positive engagement of the inside faces of the clips to the forward edge and forward side portions of the metallic channel.

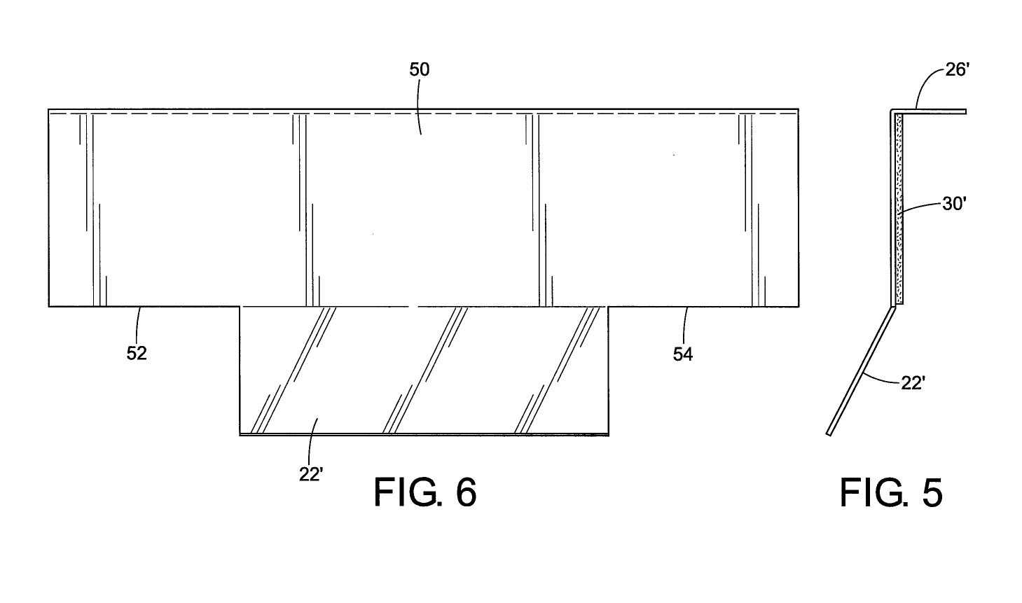

Referring now to FIGS. 5 and 6, in another embodiment, individual clips 50 can be cut from an extrusion to include extended portions or arms 52, 54 to provide increased surface area for mounting the clips to the wall. The clips also include lens 22 and a top wall 26, an adhesive type or epoxy 30 as discussed from FIGS. 1-4.

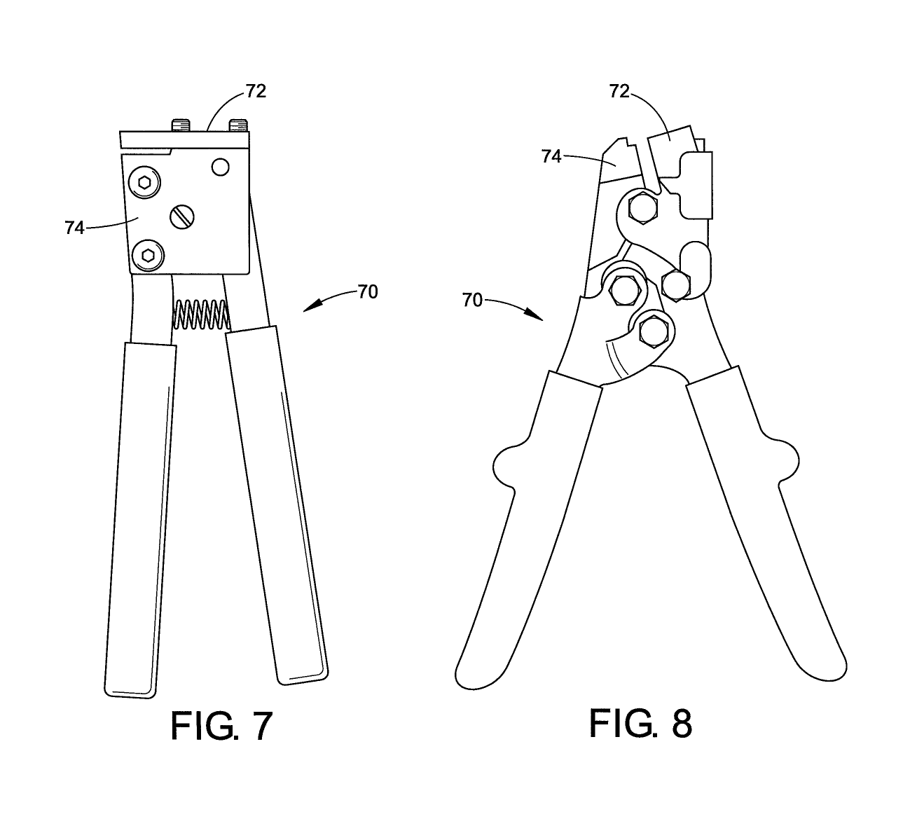

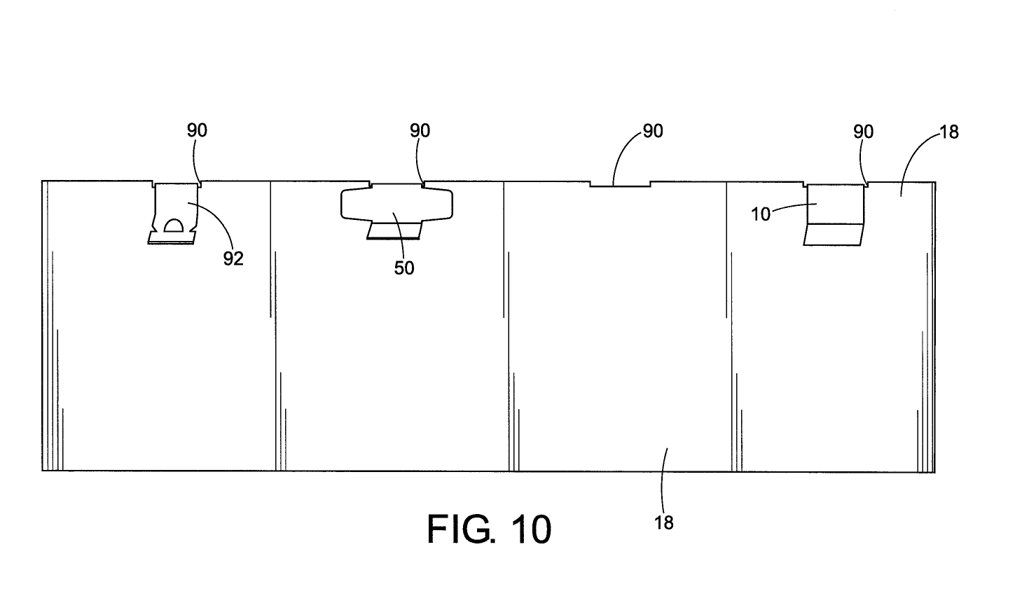

Referring to FIGS. 7 and 8, a punch tool 60 can be utilized in order to accomplish and create a size adjustment (i.e. notch) to the channel walls in order to use at least two different thicknesses of lenses, and a single sized clip, for securing the assembly to the metallic walls. The tool can punch and cut a notch 90 (FIG. 10) at any desired position to the channel walls. In one embodiment the notch includes a depth of 1/16 inch.

The punch tool can comprise a male component 72 and a female component 74 wherein the male component is adapted to cut a u-shaped groove or notches from the edge of the channel side walls as the male component is pushed through the open channel of the female component. The notches can be positioned such that they are proximal to the front edge of the side walls.

Referring to FIG. 10, the notches 90 provide an offset mounting position (i.e. 1/16 inch offset) to retainer clips such that the respective legs of the clips can be positioned to engage the associated dimensioned trim cap and two varieties of lenses. An unadjusted and an adjusted (i.e. notched) channel wall can be used to accommodate a single sized retainer clip in a first and at least a second position, respectively, for mounting with two differently dimensioned lenses. Clips 10, 50 and a clip 92 having a notch adapted for ⅛ inch clip use are shown and with notch 90.

The different dimensioned lenses 40 can include thicknesses of ⅛ inch and 3/16 inch. When a channel sign assembly is assembled using the clips 10, 50 as described, the finished product will present a more attractive appearance than one assembled using screws. In addition, when it is time to service the sign assembly to replace LEDs, or other devices, the trim or retainer cap 12 can be pried off, which will allow the service technician to free the entire perimeter, or a desired portion thereof, of the retainer cap from the forward end of the channel sign enclosure without the use of a screwdriver and the cumbersome removal of screws.

Referring again to FIG. 9, the trim cap 12 includes upper section 82, bottom or foot section 84 and middle or leg portion 86. Upper section 82 has a surface 85 which engages lens upper surface 41. Bottom portion 87 has a face 87 which engages leg 22 of clip 10 and the methods of forming will be described in detail hereinafter. The trim cap includes a through hole 80 in upper section 82 that provides at least two functional improvements to trim caps heretofore manufactured. During the plastic extrusion process, the through hole 80 allows the upper section 82 to cool and cure at a rate that is relatively similar to the cure rate of bottom section 84, thereby enabling the trim cap to remain in a substantially planar arrangement. Further, the through hole 80 enables installers, during the installation process, to easily manipulate the upper section of the trim cap. In this manner, the trim cap can be clipped and secured into place using the aforementioned retainer clips without an undo amount of force. The installation process is a manual process and the upper sections improved formability reduces the forces needed by the installer. One exemplary plastic material used in the extrusion of the trim cap is a CAB, cellulose acetate butyrate, material. Other exemplary materials include Tenite™, propionate, and other butyrates. In one particular arrangement, the trim cap is made from CAB 576E material supplied by Eastman Chemicals. Other materials can be used, such as, thermoplastic materials, polycarbonate, rigid PVC, high impact acrylic, and similar.

The trim cap 12, along with the plastic products described above, can be extruded without a metal or foil liner. The extrusion process maintains a steady pressure on the plastic being extruded in order to form linear extrusions of the trim cap. It is to be appreciated, that the respective cross-sectional areas of the upper and lower sections provide for a more consistent cooling rate, thereby eliminating a resultant curvature or bowing that results when the sections cool at different rates.

In one exemplary embodiment, the CAB comprises a 10% plasticizer. The trim cap 12 as described herein (i.e. without a foil or metal liner) can be manufactured at a relatively lower cost when compared to trim caps that include a metal liner. During extrusion, the CAB 576E can be drawn down and pulled away from the die at a draw down rate in a range from about 25% to about 50%. The extrusion passes through the initial die and then passes through to a calibration die. The calibration die represents the desired finished shape of the trim cap. The relative cross-sectional areas of the top and bottom sections 82, 84 along with the through hole 80 of the top section, coupled with the dimensions of the connecting middle leg section provides for a trim cap that extrudes in a linear arrangement without undesired curvature.

The relative cross-sectional area of the top portion of the trim cap relative to the cross-sectional area of the bottom portion of the trim cap provides for a consistent cool down rate or period of the respective end portions after extrusion. In particular, the top portion cross-sectional area, comprising a generally centered hole therethrough, allows the top portion to cool at generally the same rate or time period as the bottom portion. It is to be appreciated that the bottom cross-sectional area is from about 40% to about 60% of the top portion cross-sectional area. However, the hole, maintained in a relatively centered position in the top portion, enables the top portion to cool at relatively the same rate as the bottom portion. This enables the trim cap, in particular the connecting side or middle leg portion 86 between the top and bottom portions 82, 84 to remain straight throughout the extrusion process and the cool down process. The extrusion and cool down process of the trim cap is completed without an internal metal liner as used in the existing art. The hole in the upper portion of the trim cap comprises a diameter from about 0.04 in. to about 0.07 in. It is to be appreciated that the hole in the upper portion of the trim cap represents a reduction in cross-sectional surface area of the upper portion from about 5% to about 15%. The angle of the bottom portion relative to the connecting leg portion is from about 78° to about 88°.

The trim cap 12, as described above, can be extruded without an aluminum foil embedded therein. This allows the extrusion to be manufactured less expensively. The process also eliminates delaminating as the entire cross sectional area of the trim cap is CAB, except for the hole through the top area or portion of the trim cap extrusion. The hole reduces a small amount of material but allows for consistent cooling between the top and bottom portions or sections, as well as enabling easier forming during installation for the multitude of letter shapes for which the trim is used in the sign industry. Thus, the aforementioned trim cap eliminates the foil liner which results in a less expensive manufacturing process and a trim cap which is easier to form around the channel letter walls.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A channel design pattern comprising:
an enclosure having at least two opposing walls;
said at least two opposing walls having an inner surface and a forward end;
a plurality of selectively positioned and oriented retention clips adjacent said forward end;
wherein each of said clips include at least one outwardly extending leg relative to an outer surface of one of said walls;
a retainer cap positioned against a forward surface of a lens for retaining said lens adjacent said enclosure and said walls;
said retainer cap includes an interior face having a first edge and an opposing second edge;
said first edge having an overhang engaged to said forward surface of said lens; and,
said second edge having a channel, wherein said channel is adapted to securely engage one of said legs of said clips along an outer surface of said enclosure walls.

2. The channel design pattern of claim 1, wherein said at least two opposing walls define a shape or a letter.

3. The channel design pattern of claim 1, wherein said lens has a forward surface and an outer shape in the form of a letter.

4. The channel design pattern of claim 1, wherein said retention clips frictionally engage said forward end of one of said opposing walls.

5. The channel design pattern of claim 1, wherein said retainer cap comprises a liner less extrusion.

6. The channel design pattern of claim 1, wherein said clips each comprises an adhesive bond securing one of said clips to one of said walls.

7. A channel sign assembly, comprising:
an enclosure having at least two opposing walls defining a shape of a sign assembly, wherein said at least two opposing walls have a forward end;
a plurality of intermittent retention clips are mounted adjacent said forward end;
wherein each of said clips comprises a top edge, a body and an outwardly extending leg relative to said body;
a planar lens having a forward surface and an outer edge in the shape of a sign;
and a plurality of retainer caps are mounted adjacent the forward surface of said lens for retaining said lens and said caps are secured by one of said legs of said clips.

8. The channel design pattern of claim 7, wherein said retention clips frictionally engage said forward end of one of said opposing walls.

9. The channel design pattern of claim 7, wherein said retainer cap comprises a liner less extrusion.

10. The channel sign assembly of claim 7, wherein said plurality of clips each comprises adhesive bond for securing one of said clips to one of said walls.

11. A channel sign assembly, comprising:
at least one retention clip comprising:
a body having a first leg; an angled top side and a wall extending between said top side and said leg wherein said clip is adapted to be secured to an associated wall of a channel;
at least one retainer cap comprising an upper portion; bottom foot portion, and a leg section extending from said upper portion to said bottom leg portion;
wherein said leg of said clip engages said bottom foot portion of said cap to retain said cap; and
wherein said upper portion of said cap is adapted to receive an associated lens for securing said lens to said associated wall of said channel.

12. The channel sign assembly of claim 11, wherein said retention clips frictionally engage a forward end of said associated wall.

13. The channel sign assembly of claim 11, wherein said retainer cap comprises a liner less extrusion.

14. The channel sign assembly of claim 11, wherein said clips each comprises an adhesive bond securing one of said clips to said associated walls.
